(19) United States
(12) Patent Application Publication
(10) Pub. No.: US 2007/0226373 A1
(43) Pub. Date: Sep. 27, 2007

(54) NETWORK DEVICE AND METHOD FOR ESTABLISHING COMMUNICATIONS

(75) Inventor: CHU-FENG LIEN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/608,801

(22) Filed: Dec. 9, 2006

(30) Foreign Application Priority Data
Mar. 24, 2006 (TW) 095110338

(51) Int. Cl. G06F 15/16

(52) U.S. Cl. 709/248

(57) ABSTRACT

A network device (10) for establishing communications between a first terminal device (30) and a second terminal device (50) connected to a local exchange (LE) (20) sending a communication request signal from the second terminal device to the first terminal device, includes a signal processing module (100), a timing module (110), an interface module (130), and a timeout processing module (120). The signal processing module receives a communication response signal from the first terminal device, and sends the communication response signal to the interface module. The timing module includes a first timer and a second timer. The interface module receives the communication response signal, sends the communication response signal to the LE, starts the first timer, receives a communication ready signal from the LE, and starts the second timer. The timeout processing module sends an acknowledgement (ACK) signal to the LE after the second timer has timed out.

### BACKGROUND OF THE INVENTION

1. Field of the Invention

The invention relates to network devices, and particularly to a network device for establishing and maintaining communications between network devices.

2. Description of Related Art

With development of communication networks, more and more subscribers use the public switched telephone network (PSTN). If the PSTN is busy, signals such as acknowledgement (ACK) signals may be lost.

If a first terminal device accepts a communication request signal such as a ring signal from a second terminal device, the first terminal device sends an off-hook signal to an access network device, the access network device receives the off-hook signal, sends the off-hook signal to a local exchange (LE), and starts timing. The LE first sends a polarity normal signal to the access network device, and then sends an ACK signal to the access network device. However, because the PSTN is busy, the ACK signal may be lost. If the access network device does not receive the ACK signal from the LE in a timing interval, the access network device disconnects with the LE, thereby the second terminal device fails to communicate with the first terminal device. Therefore, it is inconvenient and problematic for users of the first terminal device and the second terminal device.

### SUMMARY OF THE INVENTION

An exemplary embodiment of the invention provides a network device for establishing communications between a first terminal device and a local exchange (LE) communicating with the second terminal to establishing communications between the first terminal device and the second terminal device, the second terminal device sends a communication request signal to the first terminal device. The network device includes a signal processing module, a timing module, an interface module, and a timeout processing module. The signal processing module is used for receiving a communication response signal from the first terminal device, and sending the communication response signal to the interface module. The timing module is connected to the signal processing module, and includes a first timer and a second timer. The interface module is connected to the signal processing module and the timing module, and is used for sending the communication response signal to the LE, starting the first timer, receiving a communication ready signal from the LE, and starting the second timer. The timeout processing module is connected to the timing module and the interface module, and is used for sending an acknowledgement (ACK) signal to the LE after the second timer has timed out.

Another exemplary embodiment of the invention provides a method for establishing communications between a first terminal device and a local exchange (LE) communicating with the second terminal to establishing communications between the first terminal device and the second terminal device, the second terminal device sends a communication request signal to the first terminal device. The method includes the first terminal device accepting the communication request signal, the network device sending a communication response signal to the LE, and starting a first timer; the network device receiving a communication ready signal from the LE and starting a second timer; and the network device sending an acknowledgement (ACK) signal to the LE after the second timer has timed out.

Other advantages and novel features will become more apparent from the following detailed description when taken in conjunction with the accompanying drawings, in which:

### BRIEF DESCRIPTION OF THE DRAWINGS

FIG. 1 shows a block diagram of an application environment of a network device in accordance with an exemplary embodiment of the invention;

FIG. 2 shows a block diagram of an application environment of a network device in accordance with another exemplary embodiment of the invention;

FIG. 3 shows a flow chart of a method for establishing communications in accordance with a further exemplary embodiment of the invention; and

FIG. 4 shows a flow chart of a method for establishing communications in accordance with a still further exemplary embodiment of the invention.

### DETAILED DESCRIPTION OF THE INVENTION

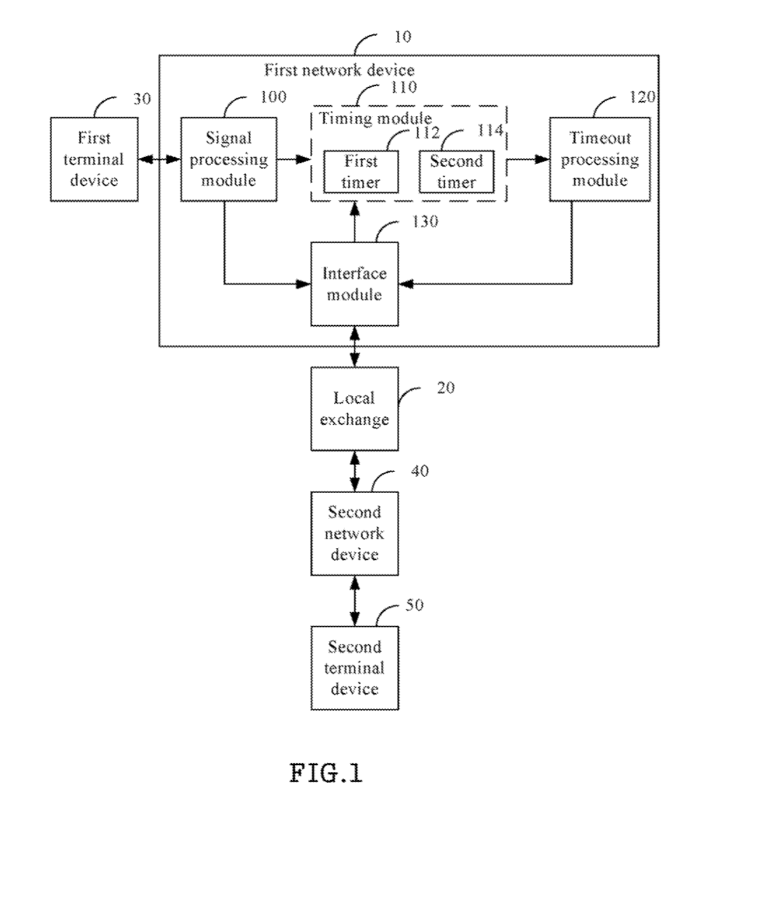

FIG. 1 shows a block diagram of an application environment of a first network device 10 in accordance with an exemplary embodiment of the invention. In the exemplary embodiment, the first network device 10 is connected between a first terminal device 30 and a local exchange (LE) 20, and a second network device 40 is connected between the LE 20 and a second terminal device 50. The first network device 10 is used for establishing communications with the LE 20, thereby establishing communications between the first terminal device 30 and the second terminal device 50. In the exemplary embodiment, the first network device 10 and the second network device 40 may be access network devices such as access points (AP), routers and etc., and the first terminal device 30 and the second terminal device 50 may be public switched telephone network (PSTN) devices, such as telephones. The LE 20 may be some other switch device.

In the exemplary embodiment, the second terminal device 50 sends a communication request signal to the first terminal device 30 via the LE 20 and the first network device 10. In the exemplary embodiment, the communication request signal may be a ring signal. If the first terminal device 30 accepts the communication request signal, the first terminal device 30 sends a communication response signal to the first network device 10. In the exemplary embodiment, the communication response signal may be an off-hook signal. The first network device 10 includes a signal processing module 100, a timing module 110, a timeout processing module 120, and an interface module 130. The signal processing module 100 is used for receiving the communication response signal from the first terminal device 30 and sending the communication response signal to the interface module 130. The timing module 110 is connected to the signal processing module 100, and includes a first timer 112 and a second timer 114. The first timer 112 corresponds to an identifier.

The interface module 130 is connected to the signal processing module 100 and the timing module 110, and is used for receiving the communication response signal from the signal processing module 100, sending the communication response signal to the LE 20, and starting the first timer 112. The LE 20 receives the communication response signal from the interface module 130, and sends a detecting signal to the second terminal 50 for detecting whether the second terminal device 50 is available. The LE 20 first sends a communication ready signal to the first network device 10 if the second terminal device 50 is available, and then sends an acknowledgement (ACK) signal to the first network device 10 in response to the communication response signal of the first network device 10. In the exemplary embodiment, the communication ready signal may be a polarity normal signal. The interface module 130 is further used for receiving the communication ready signal from the LE 20 and starting the second timer 114. In exemplary embodiment, the interface module 130 is a communication interface between the first network device 10 and the LE 20, when the interface module 130 receives the communication ready signal from the LE 20, starting the second timer 114. In the exemplary embodiment, the interface module 130 may be a V5.2 interface. In the exemplary embodiment, a timing interval of the first timer 112 may be predetermined, for example, 10 seconds, and a timing interval of the second timer 114 may be predetermined, for example, 5 seconds.

The timeout processing module 120 is connected to the timing module 110 and the interface module 130, and is used for sending another ACK signal to the LE 20 in response to the communication ready signal of the LE 20 after the second timer 114 has timed out. Then the first terminal device 30 communicates with the second terminal device 50. In the exemplary embodiment, the timeout processing module 120 sends the another ACK signal to the LE 20 via the interface module 130.

After the first network device 10 receives the communication ready signal from the LE 20, no matter whether the first timer 112 is operating, and whether the first network device 10 receives the ACK signal from the LE 20, the first network device 10 sends the another ACK signal to LE 20 for establishing communication between the first terminal device 30 and the second terminal device 50.

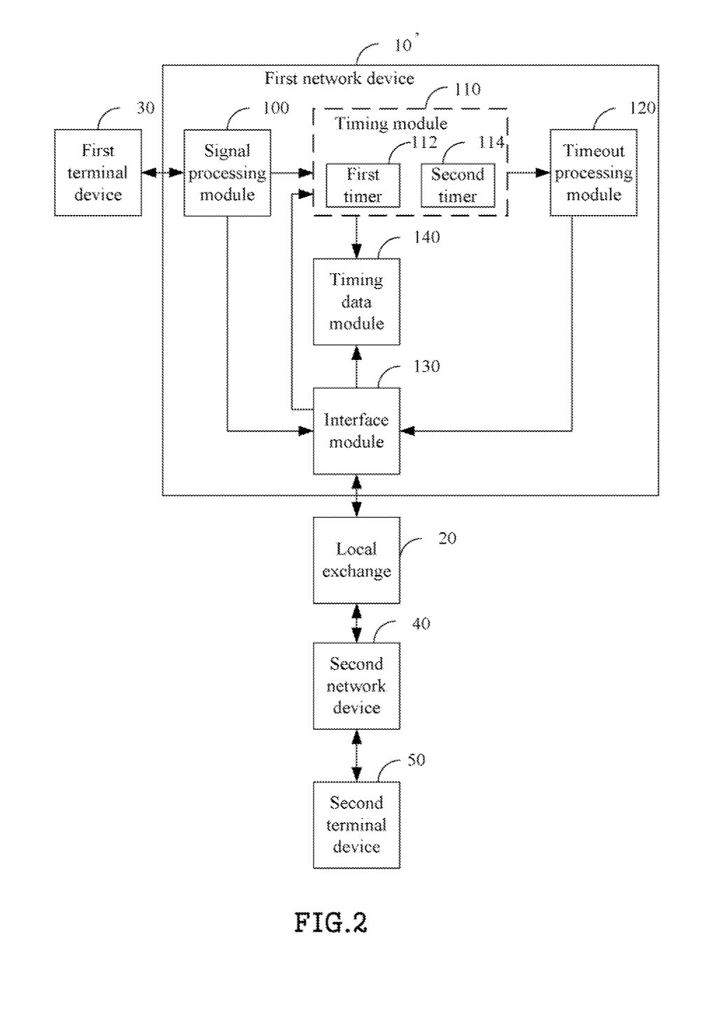

FIG. 2 shows a block diagram of an application environment of a first network device 10′ in accordance with another exemplary embodiment of the invention. In the exemplary embodiment, the difference between the first network device 10 and the first network device 10′ is that the first network device 10′ further includes a timing data module 140. Other modules of the first network device 10′ are the same as modules of the first network device 10, and therefore, descriptions thereof are omitted. The timing data module 140 is connected to the timing module 110 and the interface module 130, and is used for saving data of the first timer 112. In the exemplary embodiment, the data includes state data of the first timer 112. The states of the first timer 112 include an operating state and a stop state, respectively represented by a different symbol. For example, the operating state is represented by a symbol such as 0, and the stop state is represented by a symbol such as 1. When the first timer 112 starts, the timing module 110 sets a state of the first timer 112 to an operating state, and saves the operating state in the timing data module 140. If the first timer 112 stops timing, the timing module 110 sets a state of the first timer 112 to a stop state, and saves the stop state in the timing data module 140.

When the interface module 130 receives the communication ready signal, the interface module 130 is further used for querying the timing data module 140 to retrieve the state data of the first timer 112, determining whether the first timer 112 is operating according to the state data, and sending a stop command to the timing module 110 to stop the first timer 112, if the first timer 112 is operating. The timing module 110 receives the stop command, stops the first timer 112, sets the state of the first timer 112 to a stop state, and saves the stop state in the timing data module 140.

In another exemplary embodiment, the data of the first timer 112 further includes an identifier of the first timer 112. When the interface module 130 determines that the first timer 112 is operating, the interface module 130 queries the timing data module 140 to retrieve the identifier of the first timer 112, and sends a stop command to the timing module 110 to stop the first timer 112. In the exemplary embodiment, the stop command includes the identifier of the first timer 112. The timing module 110 receives the stop command, stops the first timer 112 according to the identifier, sets the state of the first timer to a stop state, and saves the stop state in the timing data module 140.

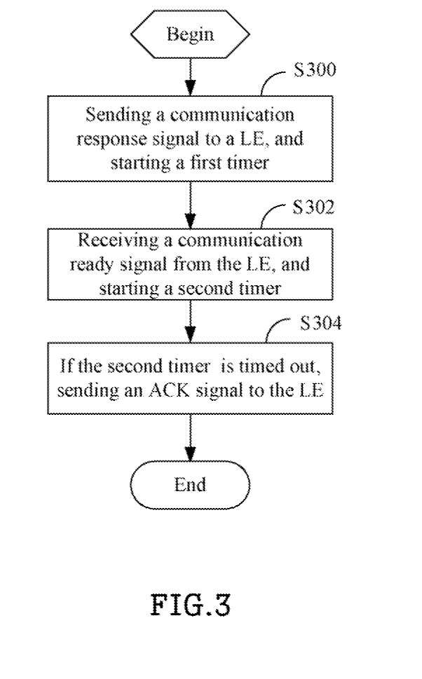

FIG. 3 shows a flow chart of a method for establishing communications in accordance with an exemplary embodiment of the invention. The signal processing module 100 receives a communication request response from the first terminal device 30, and sends the communication response signal to the interface module 130. In step S300, the interface module 130 sends the communication response signal to the LE 20, and starts the first timer 112. The LE 20 receives the communication response signal from the interface module 130, sends a detecting signal to the second terminal for detecting whether the second terminal device 50 is available, and sends back a communication ready signal to the first network device 10 if the second terminal device 50 is available. In step S302, the interface module 130 receives the communication ready signal from the LE 20, and starts the second timer 114. In step S304, if the second timer 114 has timed out, the timeout processing module 120 sends an ACK signal to the LE 20 via the interface module 130. The first network device 10 establishes communication with the LE 20, and the first terminal device 30 may communicate with the second terminal device 50.

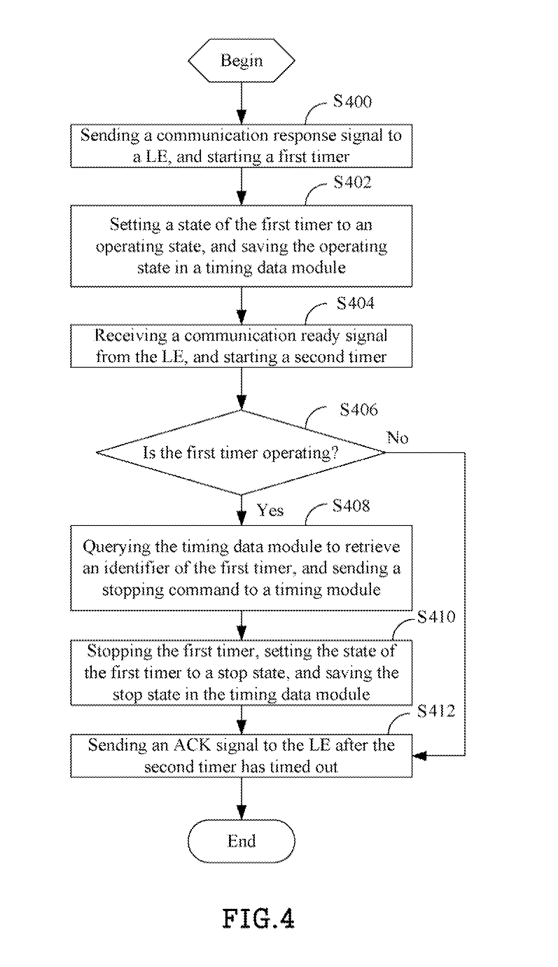

FIG. 4 shows a flow chart of a method for establishing communications in accordance with another exemplary embodiment of the invention. At first, the signal processing module 100 receives the communication response signal from the first terminal device 30, and sends the communication response signal to the interface module 130. In step S400, the interface module 130 sends the communication response signal to the LE 20, and starts the first timer 112. In step S402, the timing module 110 sets a state of the first timer 112 to an operating state, and saves the operating state in the timing data module 140. The LE 20 receives the communication response signal from the interface module 130, sends a detecting signal to the second terminal for detecting whether the second terminal device 50 is available, and sends back a communication ready signal to the first network device 10′ if the second terminal device 50 is available. In step S404, the interface module 130 receives the communication ready signal, and starts the second timer 114. In step S406, the interface module 130 queries the timing data module 140 to retrieve the state data of the first timer 112, and determines whether the first timer 112 is operating.

If the first timer 112 is operating, in step S408, the interface module 130 queries the timing data module 140 to retrieve an identifier of the first timer 112, and sends a stop command to the timing module 140 to stop the first timer 112. In the exemplary embodiment, the stop command includes the identifier of the first timer 112. In step S410, the timing module 110 receives the stop command, stops the first timer 112, sets the state of the first timer 112 to a stop state, and saves the stopping state in the timing data module 140.

If the first timer 112 is not operating or stops timing, the process turns to the step S412. In step S412, the timeout processing module 120 sends an ACK signal to the LE 20 via the interface module 130 after the second timer 114 has timed out.

The first network device 10 and/or the first network device 10′ establishes communication with the LE 20 after the communication ready signals are received from the LE 20, thereby avoiding communication failure caused by the loss of the ACK signals of the LE 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments.

What is claimed is:

1. A network device for establishing communications between a first terminal device and a local exchange (LE) communicating with a second terminal device to establish communications between the first terminal device and the second terminal device, the second terminal sends a communication request signal to the first terminal device, comprising:
a signal processing module connected to the first terminal device, for receiving a communication response signal from the first terminal device to the communication request signal, and transmitting the communication response signal;
a timing module connected to the signal processing module, comprising a first timer and a second timer;
an interface module connected to the signal processing module and the timing module, for receiving the communication response signal from the signal processing module, and sending the communication response signal to the LE, starting the first timer; after receiving a communication ready signal from the LE, starting the second timer; and
a timeout processing module connected to the timing module and the interface module, for sending an acknowledgement (ACK) signal to the LE after the second timer has timed out.

2. The network device of claim 1, further comprising a timing data module connected to the timing module and the interface module, for saving state data of the first timer.

3. The network device of claim 2, wherein the interface module is further used for querying the timing data module to retrieve the state data of the first timer, and determining the state of the first timer.

4. The network device of claim 3, wherein the interface module is further used for sending a stop command to the timing module if the first timer is operating.

5. The network device of claim 4, wherein the timing data module is further used for saving an identifier of the first timer, and the interface module is further used for querying the timing module to retrieve the identifier of the first timer.

6. The network device of claim 5, wherein the identifier of the first timer comprises a stop state and an operating state.

7. The network device of claim 1, wherein the timeout processing module sends the ACK signal to the LE via the interface module.

8. The network device of claim 1, wherein the communication request signal is a ring signal, the communication response signal is an off-hook signal, and the communication ready signal is a polarity normal signal.

9. The network device of claim 1, wherein the network device is an access network device.

10. A method for establishing communications between a first terminal device and a local exchange (LE) communicating with a second terminal device to establishing communications between the first terminal device and the second terminal device, the second terminal device sends a communication request signal to the first terminal device, comprising:
the first terminal device accepting the communication request signal, a network device, communicable between the first terminal device and the LE, sending a communication response signal to the LE, and starting a first timer;
the network device receiving a communication ready signal from the LE; and
the network device stopping the first timer based on receipt of the communication ready signal from the LE.

11. The method for establishing communications of claim 10, further comprising:
setting a state of the first timer to an operating state, and saving the operating state in a timing data module.

12. The method for establishing communications of claim 1, wherein the timing data module saves state data of the first timer.

13. The method for establishing communications of claim 12, further comprising:
querying the timing data module to retrieve the state data of the first timer, and determining whether the first timer is operating; and
sending a stop command to the timing module if the first timer is operating.

14. The method for establishing communications of claim 13, wherein the timing data module saves an identifier of the first timer, the identifier of the first timer comprises a stop state and an operating state.

15. The method for establishing communications of claim 14, wherein the step of sending the stop command to the timing module comprises:
querying the timing data module to retrieve the identifier of the first timer.

16. The method for establishing communications of claim 10, further comprising
starting a second timer when the network device receives a communication ready signal from the LE; and
the network device sending an acknowledgement (ACK) signal to the LE after the second timer has timed out.

17. The method for establishing communications of claim 13, further comprising:
receiving the stop command, stopping the first timer; and
setting the state of the first timer to an stopping state, and saving the stopping state in the timing data module.

18. The method for establishing communications of claim 10, wherein the communication request signal is a ring signal, the communication response signal is an off-hook signal, and the communication ready signal is a polarity normal signal.

19. A method for establishing communications between a first terminal device and a second terminal device through at least one network device and a local exchange (LE), comprising steps of:
transmitting a communication request signal from an LE to a network device further communicable with one of a first terminal device and a second terminal device after said LE receives another communication request signal from the other of said first and second terminal devices to request for establishing communication between said first and second terminal devices through said LE;
sending a communication response signal from said network device to said LE in response to said communication request signal from said LE;
starting a timer simultaneously in said network device when said network device sends said communication response signal;
receiving an identifiable signal from said LE other than an acknowledgement (ACK) signal from said LE in response to said communication response signal after said network device sends said communication response signal to said LE; and
terminating timing of said timer based on receipt of said identifiable signal from said LE other than said ACK signal.

20. The method for establishing communications of claim 19, wherein said identifiable signal is a communication ready signal transmissible from said LE to said network device.
